(19) United States
(12) Patent Application Publication
(10) Pub. No.: US 2012/0200956 A1
(43) Pub. Date: Aug. 9, 2012

(54) METHOD FOR PRODUCING MAGNETIC RECORDING MEDIUM, AND MAGNETIC RECORDING AND REPRODUCING DEVICE

(75) Inventors: Shinichi ISHIBASHI, Tokyo (JP); Tsubasa OKADA, Ichihara-shi (JP); Akira YAMANE, Ichihara-shi (JP); Tomoo SHIGE, Chiba-shi (JP); Manabu UEDA, Nabari-shi (JP); Zhipeng WANG, Oyama-shi (JP); Yuji MURAKAMI, Ichihara-shi (JP)

(73) Assignee: SHOWA DENKO K.K., Tokyo (JP)

(21) Appl. No.: 13/362,271

(22) Filed: Jan. 31, 2012

(30) Foreign Application Priority Data
Feb. 7, 2011 (JP) 2011-024057

(51) Int. Cl. G11B 5/52; G11B 5/84

(52) U.S. Cl. 360/86; 216/22; G9B/5.173

(57) ABSTRACT

A method for producing a magnetic recording medium which includes: forming a magnetic layer on a non-magnetic substrate; forming a dissolution layer on the magnetic layer; forming a mask layer on the dissolution layer; patterning the dissolution layer and the mask layer so as to have a pattern corresponding to a magnetic recording pattern; partially modifying or removing a part of the magnetic layer and the mask layer not covered with the dissolution layer; and dissolving the dissolution layer and removing the dissolution layer together with the mask layer which is on the dissolution layer from the surface of the magnetic layer. The dissolution layer is formed by coating a solution containing an organic silicon compound dissolved in an organic solvent on the magnetic layer, and solidifying the coated chemical solution in the step in which the dissolution layer is formed on the magnetic layer.

### CROSS-REFERENCE TO RELATED APPLICATIONS

This application is based on Japanese Patent Application No. 2011-024057 filed in Japan on Feb. 7, 2011, the content of which is incorporated herein by reference.

### TECHNICAL FIELD

The present invention relates to a method for producing a magnetic recording medium used in a hard disk drive (HDD) or a similar device, and to a magnetic recording and reproducing device.

### BACKGROUND ART

In recent years, magnetic recorders, such as magnetic disk units, flexible disk units, and magnetic tape units, have been used over a remarkably wider range of application, and play more important roles. With this trend, an attempt is being made to highly increase the recording density of magnetic recording media for used in such recorders. In particular, the in-plane recording density has been vigorously increasing since the introduction of an MR head and PRML technology. Moreover, since a GMR head and a TMR head have also been introduced in recent years, the in-plane recording density keeps increasing at a rate as high as about 1.5 times.

Regarding these magnetic recording media, there is a demand for a further increase of the recording density in the future. It is therefore necessary to increase the coercive force, the signal-to-noise ratio (SNR) and resolution of the magnetic layer. In recent years, efforts to increase the in-plane recording density have been made by increasing the track density simultaneously with increasing the linear recording density. The most recent magnetic recording media have a track density of as high as 250 kTPI. As the track density increases, however, magnetic recording information between adjacent tracks begins interfering with each other. As a result, a magnetizing transition area in a border area becomes a noise source, which may easily decrease the SNR. The decrease in the SNR may directly lead to a decrease in a bit error rate and prevent an improvement in recording density.

In order to increase the in-plane recording density, it is necessary to make the size of each recording bit on the magnetic recording medium finer and to secure the biggest possible saturation magnetization and the magnetic film thickness to each recording bit. However, as the recording bit becomes finer, the magnetizing minimum volume per 1 bit becomes small and recorded data may disappear by magnetization reversal caused by heat fluctuation.

In addition, as the track density increases, since the adjacent tracks come close to each other, a very highly precise track servo technique is necessary for the magnetic recording device. Usually, information is recorded on a wide track and reproduced in a narrower tack in order to avoid influence from adjacent tracks to the minimum. Although influence between the tracks can be suppressed to the minimum by this method, however, it is difficult to obtain a sufficient reproduction output and it is thus difficult to provide a sufficient SNR.

In order to recognize the problems of the heat fluctuation and reliability of the SNR or to provide sufficient outputs, unevenness along the track is formed on the surface of the recording medium so as to isolate the recording tracks physically from one another to increase the track density. Such a technique is usually called a discrete track method and a magnetic recording medium produced thereby will be called a discrete track medium. An attempt has also been made to provide a “patterned medium” which has further divided data area in a track.

An exemplary discrete track medium is a magnetic recording medium which is formed on a non-magnetic substrate having a uneven pattern formed thereon and a physically-isolated magnetic recording track and a servo signal pattern are formed on the medium (for example, see Japanese Unexamined Patent Application, First Publication No. 2004-164692).

In the disclosed magnetic recording medium, a ferromagnetic layer is formed via soft magnetic layer on the surface with plural unevenness of the substrate. A protective film is formed on the surface of the ferromagnetic layer. In this magnetic recording medium, a physically-isolated magnetic recording area is formed around a projecting area.

According to the disclosed magnetic recording medium, generation of a magnetic wall on the soft magnetic layer can be avoided, and the influence of the heat fluctuation can thus be made small and no interference occurs between adjacent signals. As a result, a high-density magnetic recording medium with loss noise can be provided.

The discrete track method includes a method of forming a track after a magnetic recording medium including several layers of thin films are formed, and a method of forming an uneven pattern on a surface of the substrate directly or on a thin film layer for track formation, and then forming a thin film of a magnetic recording medium (for example, see Japanese Unexamined Patent Applications, First Publication Nos. 2004-178793 and 2004-178794).

The former method is so-called a “magnetic layer processing type method”. In this method, since the surface of the medium after producing is physically processed, the obtained medium is easily contaminated, and the steps for production method are extremely complicated. In contrast, the latter method is so-called an “emboss processing type method”. In this method, the medium during producing steps is not easily contaminated, however, the embossed shape on the substrate is easily reflected to a film which is formed on the substrate. Therefore, the floating position or height of a recording and reproducing head which records and reproduces while floating on the medium is unstable.

In addition, a method of forming an area between magnetic tracks of a discrete track medium by injecting nitrogen ions, oxygen ions or the like into a previously formed magnetic layer or by irradiating with a laser so as to change magnetic characteristics in that area is disclosed (for example, see Japanese Unexamined Patent Applications, First Publication Nos. H5-205257, 2006-209952 and 2006-309841).

Furthermore, a method of forming uneven patterns on the surface of the magnetic layer, then forming the non-magnetic layer so as to cover the surface of the magnetic layer, and making the surface of the non-magnetic layer flat by oblique ion beam etching or CMP (Chemical Mechanical Polishing) is disclosed (for example, see Japanese Unexamined Patent Application, First Publication No. 2005-135455).

### SUMMARY OF THE INVENTION

When the method, in which a continuous magnetic thin film is formed, and then magnetic recording pattern is formed by partially processing the magnetic layer or modifying the magnetic properties of the magnetic layer, is used, as a production method for patterned media, it is necessary to form a mask layer corresponding to the magnetic recording pattern on the surface of the continuous magnetic thin film.

The mask layer is required to have strength sufficient to resist the partial process of the magnetic layer or modification of the magnetic properties of the magnetic layer, and barrier properties to an ion beam. In addition, the mask layer is also required to be removed easily after the patterning step of the magnetic layer. As the material for the mask layer, which satisfies with these demands, for example, hard carbon can be used, because the hard carbon can be gasified by oxygen plasma, or the like, together with having high barrier properties to an inactive ion beam, and the like.

However, the remove of the mask layer requires a lot of time, and this decreases the productivity of the magnetic recording media. In order to remove the mask layer by plasma within a short time, dust easily remains on the surface on the magnetic layer. This causes the decrease in flatness of the surface of the magnetic recording media.

In addition, when the patterning process is insufficient due to the dust during the formation step of the mask layer, plasma etching is insufficiently carried out in the portion having the dust, and the remaining mask layer makes protrusions. When the plasma etching is intensively carried out to remove the remaining mask layer, the magnetic layer may be damaged.

Furthermore, it is possible to use CMP to increase the removel rate of the mask layer. However, it is difficult to detect the stopping place of polishing in CMP. Due to this difficulty, the surface of the magnetic layer may also be polished.

The present invention has been accomplished in view of the foregoing, and an object of the present invention is to provide a method for producing a magnetic recording medium which can remove the mask layer certainly with high speed, form a treated surface having no protrusions, and further improves productivity; and a magnetic recording and reproducing device which can further improve magnetic conversion characteristics using the magnetic recording medium produced by the method.

The present inventor has conducted extensive research to achieve the object, and has found that the mask layer can be certainly removed from the surface of the magnetic layer with high speed without remaining by forming a dissolution layer between the magnetic layer and the mask layer, and wet-dissolving the dissolution layer using a chemical solution. In addition, the present inventor has found that this method can remarkably improve the productivity of the magnetic recording medium, and produce a magnetic recording medium having high flatness. The present invention has been made on the basis of this finding.

In other words, the present invention provides the following solutions.

(1) A method for producing a magnetic recording medium having a magnetic recording pattern which is magnetically divided including:

a step in which a magnetic layer is formed on a non-magnetic substrate;

a step in which a dissolution layer is formed on the magnetic layer;

a step in which a mask layer is formed on the dissolution layer;

a step in which the dissolution layer and the mask layer are patterned so as to have a pattern corresponding to the magnetic recording pattern;

a step in which the magnetic layer, at which is not covered with the dissolution layer and the mask layer, is partially modified or removed; and

a step in which the dissolution layer is dissolved by a chemical solution and the dissolution layer is removed together with the mask layer which is on the dissolution layer from the surface of the magnetic layer;

wherein the dissolution layer is formed by coating a chemical solution, in which an organic silicon compound is dissolved in an organic solvent, on the magnetic layer, and solidifying the coated chemical solution, in the step in which the dissolution layer is formed on the magnetic layer.

(2) A method for producing a magnetic recording medium according to (1), wherein the organic silicon compound contains polysiloxane, and the organic solvent contains propylene glycol monomethyl ether or propylene glycol monomethyl ether acetate.
(3) A method for producing a magnetic recording medium according to (1) or (2), wherein the chemical solution contains isopropyl alcohol.
(4) A magnetic recording and reproducing device including:

the magnetic recording medium which is produced by the method according to any one of (1) to (3);

a media driving portion for driving the magnetic recording medium in a recording direction;

a magnetic head for recording and reproducing to the magnetic recording medium

a head movement means for moving the magnetic head relatively to the magnetic recording medium; and

a recording and reproducing signal processing means for inputting signal to the magnetic head and reproduction output signal from the magnetic head.

### BRIEF DESCRIPTION OF THE DRAWINGS

FIG. 1 is a cross-sectional view for explaining a method for producing the magnetic recording medium according to the present invention.

FIG. 2 is a cross-sectional view for explaining another method for producing the magnetic recording medium according to the present invention.

FIG. 3 is a cross-sectional view showing one example of the magnetic recording medium produced by the method for producing the magnetic recording medium according to the present invention.

FIG. 4 is a perspective view showing one example of the magnetic recording and reproducing device fourth embodiment of the magnetic recording medium of the present invention.

### MODES FOR CARRYING OUT THE INVENTION

Below, the embodiments of the present invention will be explained. Moreover, figures used in the following description may be partially enlarged to show the characteristic features of the present invention. The size or the chart aspect ratio may be different from those of the actuality.

### (Method for Producing a Magnetic Recording Medium)

One embodiment of the method for producing a magnetic recording medium according to the present invention is explained in detail below.

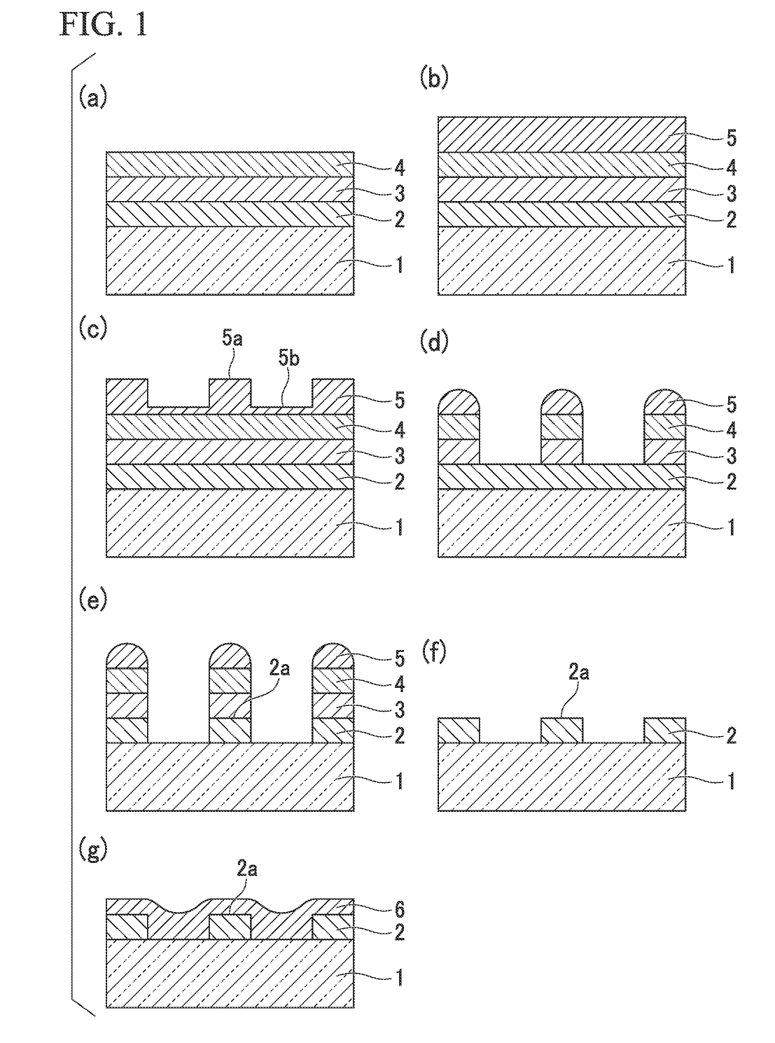

The present invention relates to the production method for the magnetic recording medium having a magnetic recording pattern which is magnetically divided. For example, as shown in FIG. 1 (a) to (g), the production method includes a step in which a magnetic layer 2 is formed on a non-magnetic substrate 1; a step in which a dissolution layer 3 is formed on the magnetic layer 2; a step in which a mask layer 4 is formed on the dissolution layer 3; a step in which a resist layer 5 is formed on the mask layer 4; a step in which the surface of the resist layer 5 is patterned so as to correspond to a magnetic recording pattern; a step in which the mask layer 4 and the dissolution layer 3 are patterned using the patterned resist layer 5; a step in which the magnetic layer 5 is partially removed such that the magnetic layer 2 at which is not covered with the resist layer 5, the mask layer 4 and the dissolution layer 3, is removed; a step in which the dissolution layer 3 is wet-dissolved using a chemical solution and the mask layer 4 and the resist layer 5, which are formed on the dissolved dissolution layer 3, are removed from the magnetic layer 2; a step in which a protective layer 6 is formed on the obtained laminate, and a step in which a lubricant layer (not shown in Figures) is formed on the protective layer 6.

Specifically, these steps are explained below.

First, as shown in FIG. 1(a), the magnetic layer 2, the dissolution layer 3 and the mask layer 4 are formed on the non-magnetic layer 1 in this order. Then, as shown in FIG. 1(b), after forming the resist layer 5, the resist layer 5 is patterned so as to correspond to a magnetic recording pattern by a photolithography method or a nano-in-printing method. Thereby, a pattern, which has protrusions 5a corresponding to the magnetic recording pattern and recesses 5b between the protrusions 5a, is formed on the surface of the resist layer 5, as shown in FIG. 1(c).

When the resist layer 5 is patterned, it is preferable to use the nano-in-printing method. In the nano-in-printing method, the resist layer 5 is made of a material which is cured by being irradiated with a radical ray, and a pattern is formed on the resist layer 5 by transferring the pattern using a stamp (not shown in Figures).

Moreover, it is preferable to irradiate a radical ray to the resist layer 5 after the pattern is transferred. Thereby, it is possible to transfer the shape of the stamp to the resist layer 5 with high accuracy, and improve the patterning characteristic of the magnetic recording in the present invention.

In particular, when the pattern is transferred to the he resist layer 5 using the stamp, it is possible to transfer the shape of the stamp to the resist layer 5 by pressing the stamp to the resist layer 5 with force under the conditions in which the resist layer 5 has high fluidity, irradiating the resist layer with a radical ray to cure while being pressed with force, then, separating the stamp from the resist layer 5. Thereby, the shape of the stamps can be transferred to the resist layer 5 with high accuracy.

Examples of the method for irradiating a radical ray to the resist layer 5 while the resist layer 5 is pressed by the stamp with force include a method of irradiating a radical ray to the resist layer 5 from the opposite side of the stamp, that is, from the side of the non-magnetic substrate 1, a method of selecting a material which transfers a radical ray as the material for the stamp and irradiating a radical ray from the side of the stamp, a method of irradiating a radical ray from the lateral side of the stamp, and a method of using a radical ray which has high conductivity to a solid, such as heat ray, and irradiating the radical ray from the stamp or the non-magnetic substrate 1 using thermal conduction.

Moreover, a “radical ray” in the present invention has wide concept, and examples of a “radical ray” includes a heat ray, a visible ray, an ultraviolet ray, an X ray, a gamma ray. In addition, examples of the material which is cured by irradiating a radical ray include a thermosetting resin to a heat ray, and an ultraviolet curable resin to an ultraviolet ray.

Among these materials, it is preferable that an ultraviolet curable resin, such as novolac-type resins, acrylic ester resins, and alicyclic epoxy resins be used as the material for the resist layer 5, and glass or a resin which has high permeability to an ultraviolet ray be used as the material for the stamp.

In the step for transferring the pattern, it is possible to use a stamp having a fine track pattern formed by drawing with electron ray to a metal plate as the stamp. The stamp is required to have hardness and durability enough to the step for transferring the pattern. Due to these requirements, the stamp is made of Ni, and the like. However, as long as being satisfied with these requirements, any material can be used as the stamp. In addition, it is also possible to form servo signal patterns such as a burst pattern, a gray code pattern, a preamble pattern, in addition to the track for recording common data.

Then, the mask layer 4 at which is not covered with the resist layer 5 is removed by introducing oxygen gas into an ICP (Inductive Coupled Plasma) device and carrying out reactive ion etching using the patterned resist layer 5.

It is preferable that the mask layer 4 be a carbon film. The carbon film can be laminated by a sputtering method or a CVD method. However, when the CVD method is used, the carbon film having higher compactness can be obtained. Since the carbon film can be processed easily by dry-etching (reactive ion etching or reactive ion milling) using oxygen gas, it is possible to decrease the amount of residue and the degree of contamination of the surface of the magnetic recording medium.

It is preferable that the thickness of the mask layer 4 be in a range from 5 nm to 40 nm, and more preferably in a range from 10 nm to 30 nm. When the thickness of the mask layer 4 is less than 5 nm, the edge portions of the mask layer 4 cannot be orderly laminated, and the patterning characteristics of the magnetic recording pattern worsens. In addition, ions, which pass through the resist layer 5, the mask layer 4 and the dissolution layer 3, come into the magnetic layer 2, and worsen the magnetic properties of the magnetic layer 2. In contrast, when the thickness of the mask layer 4 exceeds 40 nm, the time required for etching becomes longer, and the productivity decreases. In addition, residue generated in etching the mask layer 4 easily remains on the surface of the magnetic layer 2.

After that, the dissolution layer 3 under the mask layer 5 at which is not covered with the resist layer 5 and the mask layer is removed by continuously dry-etching, such as reactive ion etching or ion milling. Thereby, it is possible to pattern the mask layer 4 and the dissolution layer 3 so as to have a pattern corresponding to the magnetic recording pattern, as shown in FIG. 1(d).

Then, as shown in FIG. 1(e), the magnetic layer 2 under the dissolution layer 3 at which is not covered with the resist layer 5, the mask layer 4 and the dissolution layer 3 is removed by continuously dry etching such as reactive ion etching or ion milling, and the magnetic recording pattern 2a, which is magnetically divided, is formed.

In the present invention, when the mask layer 4 at which is not covered with the resist layer 5 is removed by reactive ion etching in the ICP device, oxygen gas is preferably used, as explained above. However, when the dissolution layer 3 and the magnetic layer 2 is removed by dry etching, which is carried out after removing the mask layer 4, it is preferable to introduce inert gas such as Ar gas or N₂ gas into a reactive ion etching device, such as ICP and RIE. In other words, it is preferable to use respectively most suitable milling ions for the mask layer 4 and for the dissolution layer 3 and the magnetic layer 2. Specifically, when the mask layer 4 is removed, ICP using oxygen gas is preferably used, and when the dissolution layer 3 and the magnetic layer 2 are removed, ion milling using Ar gas or N₂ gas is preferably used.

It is possible to form the edge portions of the remaining magnetic layer 2 vertical by these steps in the present invention. Since the dissolution layer 3 and the mask layer 4 on the magnetic layer s has vertical lateral sides, the magnetic layer 2, which is formed under these layers 3 and 4, has also the same shape as the shape of these layers 3 and 4. Therefore, the magnetic layer 2 (the magnetic recording pattern 2a) having excellent fringe characteristics can be obtained.

Next, as shown in FIG. 1(f), the dissolution layer 3 is wet-dissolved, and thereby the dissolution layer 3 is certainly removed within a short time together with the mask layer 4 and the resist layer 5. In order to dissolve certainly the dissolution layer 3 within a short time without remaining, it is necessary to select appropriately the material for the dissolution layer 3 and the chemical solution to dissolve the dissolution layer 3.

Specifically, the dissolution layer 3 is formed by coating a coating solution in which an organic silicon compound is dissolved in an organic solvent on the magnetic layer 2, and solidifying the coated solution. The organic silicon compound denotes an organic compound having a bond between a carbon and a silicon. Examples of the organic silicon compound include organic silanes, siloxides, silyl hydrides, and silenes. In the present invention, it is preferable to use the organic silicon compound which is dissolved in organic solvents, has excellent coating properties, and makes a thin film by heating or evaporation of the organic solvent after coating the coating solution on the magnetic layer 2. Specifically, siloxane or polysiloxane, which is a polymer of siloxane, is preferably used in the present invention. In contrast, preferable examples of the organic solvent include the organic solvent containing propylene glycol monomethyl ether and propylene glycol monomethyl ether acetate.

The period of time for dissolving the dissolution layer 3 by the chemical solution varies depending on the concentration or the temperature of the chemical solution, the material and the thickness of the dissolution layer 3, and the like. In order to prevent damages of the magnetic layer 2 by the chemical solution, it is preferable to dissolve the dissolution layer 3 in a range from 10 seconds to 1 hour.

After dissolving the dissolution layer 3 by the chemical solution, in order to remove the chemical solution attached to the surface of the substrate, it is preferable that the method according to the present invention include a cleaning step using pure water or a neutralization step using an acid or alkali chemical solution. In addition, since residue of the mask layer 4 or the resist layer 5 may attach to the surface of the substrate, it is preferable to include a scrub step using urethane foam in the present invention.

Then, as shown in FIG. 1(g), the protective layer 6 is formed so as to cover the surface of the laminate from which the dissolution layer 3, the mask layer 4 and the resist layer 5 are removed. In general, the protective layer 6 is a DLC (Diamond Like Carbon) thin film which is formed by a P-CVD method, however, the protective layer 6 in the present invention is not limited to this embodiment. The protective layer 6 has a thickness which is sufficient to fill the gaps between the magnetic layer 2 which is formed by removing the magnetic layer 2.

After that, the lubricant film (not shown in Figures) is formed by coating the lubricant on the protective layer 6. Examples of the lubricant include fluorine-based lubricants, hydrocarbon-based lubricants, and mixtures thereof. In general, the lubricant film has a thickness of 1 nm to 4 nm.

The magnetic recording medium can be produced by these steps.

In the production method for the magnetic recording medium according to the present invention, since the dissolution layer 3 is formed between the magnetic layer 2 and the mask layer 4, and the dissolution layer 3 is wet-dissolved by the chemical solution, it is possible to remove certainly all the mask layer 4 within a short time from the surface of the magnetic layer 2 without remaining.

In the traditional production method, the mask layer 4 which is a carbon film is removed by ashing with oxygen plasma. In this case, since defect portions at which the pattern is not formed have a small surface area, almost all of the mask layer 4 is not removed, and remains. This decreases the surface flatness of the magnetic recording medium and causes the head clash. In contrast, when ashing is performed strongly so as to remove the mask layer 4, the magnetic layer 2 under the mask layer 4 may be damaged.

In contrast, the dissolution layer 3 between the magnetic layer 2 and the mask layer 4 is dissolved by the chemical solution, and the dissolution layer 3 is removed together with the mask layer 4 in the present invention. Therefore, it is possible to remove certainly the mask layer 4 within a short time without damaging the surface of the magnetic layer 2.

As explained above, according to the production method of the present invention, it is possible to remove certainly the mask layer 4 on the magnetic layer 2 within a short time. Therefore, it is possible to produce the magnetic recording medium having high surface flatness with high productivity. In addition, the magnetic recording and reproducing device including the magnetic recording medium can improve further electromagnetic conversion properties.

Below, another production method for the magnetic recording medium according to the present invention is explained.

The present invention relates to a production method for the magnetic recording medium having a magnetic recording pattern which is magnetically divided. The present invention includes a production method for the magnetic recording medium, wherein the magnetic properties of the magnetic layer 2 are partially modified.

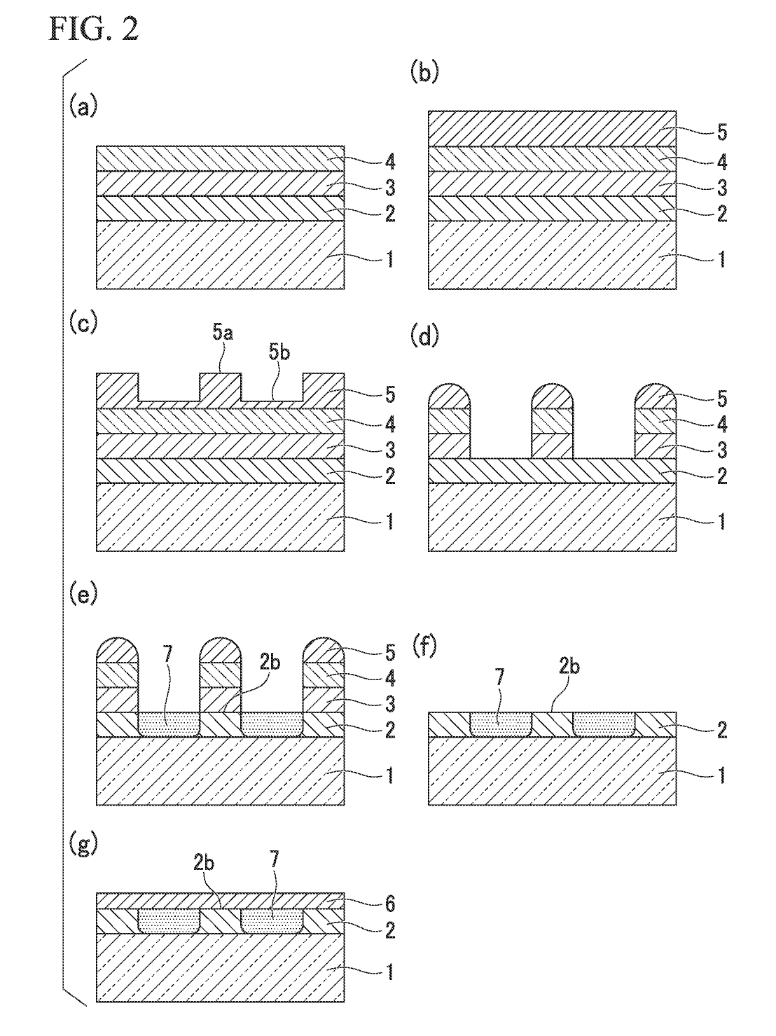

As shown in FIGS. 2(a) to 2(g), the production method for the magnetic recording medium wherein the magnetic properties of the magnetic layer 2 are partially modified includes a step for forming the magnetic layer 2 on the non-magnetic substrate 1, a step for forming the dissolution layer 3 on the magnetic layer 2, a step for forming the mask layer 4 on the dissolution layer 3, a step for forming the resist layer 5 on the mask layer 4, a step for patterning the surface of the resist layer 5 so as to correspond to the magnetic recording pattern, a step for patterning the mask layer 4 and the dissolution layer 3 using the patterned resist layer 5, a step for modifying partially the magnetic layer 2 using the patterned mask layer 4, a step for wet-dissolving the dissolution layer 3 using the chemical solution and removing the dissolution layer 3 together with the mask layer 4 which is formed on the dissolution layer 3 from the surface of the magnetic layer 2, a step for forming a protective layer 5 on the obtained laminate, and a step for forming the lubricant film on the protective layer 5 (not shown in Figures).

The steps shown in FIGS. 2(a) to 2(d) are basically the same as those shown in FIGS. 1(a) to 1(d). Therefore, the explanations for the steps shown in FIGS. 2(a) to 2(d) are omitted here.

As shown in FIG. 2(e), the magnetic layer 2 under the dissolution layer 3 at which is not covered with the resist layer 5, the mask layer 4 and the dissolution layer 3 is partially modified by reactive plasma or reactive ion, for example. Thereby, the magnetic recording pattern 2b, which is divided magnetically each other, is formed.

In the present invention, the “magnetic recording pattern 2b” means that when the magnetic recording medium is watched from the observe thereof, the magnetic properties of a part of the magnetic layer 2 are modified, preferably, the magnetic recording pattern 2b is divided by the non-magnetic regions 7. In other words, when the magnetic recording medium is watched from the obverse side thereof, and the magnetic layer 2 is divided, the object of the present invention can be achieved even if the bottom of the magnetic layer 2 is not divided. Therefore, the present invention includes the magnetic layer 2 having the magnetic recording pattern 2b of which the bottom is not divided.

In addition, the “modification” for the magnetic layer 2 to form the magnetic recording pattern 2b means magnetic modification for partially changing the coercive force or the residual magnetization of the magnetic layer 2. The “change” means the decrease of the coercive force and the residual magnetization.

In particular, the modification is carried out such that the magnetization degree of the magnetic layer 2 at which is subjected to reactive plasma or reactive ions is preferably 75% or less, and more preferably 50% or less, relative to the initial (without modification) magnetization degree of the magnetic layer 2. In addition, the modification is carried out such that the coercive force is preferably 50% or less, and more preferably 20% or less, relative to the initial (without modification) coercive force of the magnetic layer 2. When the discrete track-type magnetic recording medium is produced using the modification, it is possible to prevent the write track fringing while magnetically recording, and the magnetic recording medium having high in-plane recording density can be produced.

Furthermore, it is also possible to form the portions (non-magnetic regions 7) which separate the magnetic recording track and the servo signal pattern by subjecting the magnetic layer 2 with reactive plasma or reactive ions to make partially the magnetic layer 2 amorphous in the present invention. That is, the magnetic properties of the magnetic layer 2 can be modified by modifying the crystal structure of the magnetic layer 2 in the present invention.

In the present invention, making the magnetic layer 2 amorphous means making the atomic arrangement of the magnetic layer 2 be disordered atomic arrangement having no long-range order, specifically, means making conditions in which fine crystal particles having a diameter of less than 2 nm are arranged randomly. When the random atomic arrangement is analyzed, peaks showing crystal planes cannot be recognized and only halo is recognized by X-ray analysis or electron beam analysis.

Examples of the reactive plasma include inductively coupled plasma (ICP), and reactive ion plasma (RIE). Examples of the reactive ion include reactive ions in the inductively coupled plasma or the reactive ion plasma.

Examples of the inductively coupled plasma include high temperature plasma which is obtained by applying gas with high voltage so as to be plasma and generating Joule heat in the inside of the plasma due to eddy current by high frequency variable magnetic field. ICP has high electron density, therefore, it can modify the magnetic properties with high efficiency in a magnetic film having larger area, compared with making discrete track media by a traditional ion beam.

The reactive ion plasma is plasma which has high reactivity and contains reactive gas, such as O₂SF6, CHF₃, CF₄, and CCl₄. When such plasma is used, it is possible to modify the magnetic properties of the magnetic layer 2 with higher efficiency.

In the present invention, the magnetic layer 2 is modified by subjecting the magnetic layer 2 with the reactive plasma. However, it is preferable that the modification be carried out by the reaction between magnetic metal constituting the magnetic layer 2 and atoms or ions in the reactive plasma.

When the magnetic metal constituting the magnetic layer 2 and atoms or ions in the reactive plasma are reacted, the atoms or ions in the reactive plasma intrude the magnetic metal and the crystal structure of the magnetic metal varies, the composition of the magnetic metal varies, or the magnetic metal is oxidized, nitrozenized, or silicified.

In particular, it is preferable to oxidize the magnetic layer 2 by using reactive plasma containing oxygen atoms, and reacting the magnetic metal constituting the magnetic layer 2 with the oxygen atoms in the reactive plasma. When the magnetic layer 2 is partially oxidized, it is possible to decrease efficiently the residual magnetization or the coercive force of the oxidized portion of the magnetic layer 2. Thereby, it is possible to produce the magnetic recording medium having the magnetic recording pattern within a short time.

In addition, it is also preferable to add halogen atoms in the reactive plasma. In particular, F atom is preferably used as the halogen atoms. The halogen atoms can be added in the reactive plasma together with or without the oxygen atoms. As explained above, when the oxygen atoms, or the like are added in the reactive plasma, the magnetic metal constituting the magnetic layer 2 are reacted with the oxygen atoms, or the like, and the magnetic properties of the magnetic layer 2 can be modified. In this case, it is possible to further improve the reactivity by adding the halogen atoms in the reactive plasma.

In addition, when the oxygen atoms are not added in the reactive plasma, it is possible to react the halogen atoms with the magnetic alloy, and modify the magnetic properties of the magnetic layer 2. This reason cannot be explained clearly, however it can be thought that the halogen atoms in the reactive plasma etch foreign material on the surface of the magnetic layer 2, thereby, the surface of the magnetic layer 2 is cleaned, the reactivity of the magnetic layer 2 increases.

In addition, it can be thought that the cleaned surface of the magnetic layer 2 is reacted with the halogen atoms with high efficiency. When such effects are desired, it is preferable to use F atoms as the halogen atoms.

Next, the step shown in FIGS. 2 (f) and 2(g) are basically the same as those shown in FIGS. 1 (f) and 1(g). Therefore, the explanations for the step shown in FIGS. 2 (f) and 2(g) are omitted here.

Since the dissolution layer 3 between the magnetic layer 2 and the mask layer 4 is also removed together with the mask layer 4 by dissolving with the chemical solution, the mask layer 4 is certainly removed within a short time without damaging the surface of the magnetic layer 2 in the production method shown in FIG. 2. Due to this, it is possible to produce the magnetic recording medium having high flatness with high productivity.

In addition, the magnetic recording medium produced by the method shown in FIG. 2 has higher flatness of the surface thereof than that of the magnetic recording medium produced by the method shown in FIG. 1. Therefore, it is possible to lower the float height of the magnetic head. Due to this, it is possible to produce the magnetic recording medium having higher recording density.

Moreover, the present invention is not limited to these embodiments and the constitution of the present invention can be changed as far as the change of the constitution is within the scope of the present invention.

For example, the magnetic recording pattern can be formed in the magnetic layer 2 by partially removing the magnetic layer 2, that is, removing the magnetic layer 2 under the patterned mask layer 5 and dissolution layer 4 at which is not covered with the resist layer 5, the mask layer 4 and the dissolution layer 3, to form recesses in the magnetic layer 2, and then magnetic properties of the recesses are modified.

In addition, it is also possible to form the magnetic recording pattern in which a non-magnetic layer is formed in gaps between the magnetic layers by removing partially the magnetic layer 2, forming the non-magnetic layer for covering the produced portions by removing the magnetic layer 2, and subjecting the non-magnetic layer to CMP (Chemical mechanical Polishing) until the magnetic layer 2 is exposed.

### (Magnetic Recording Medium)

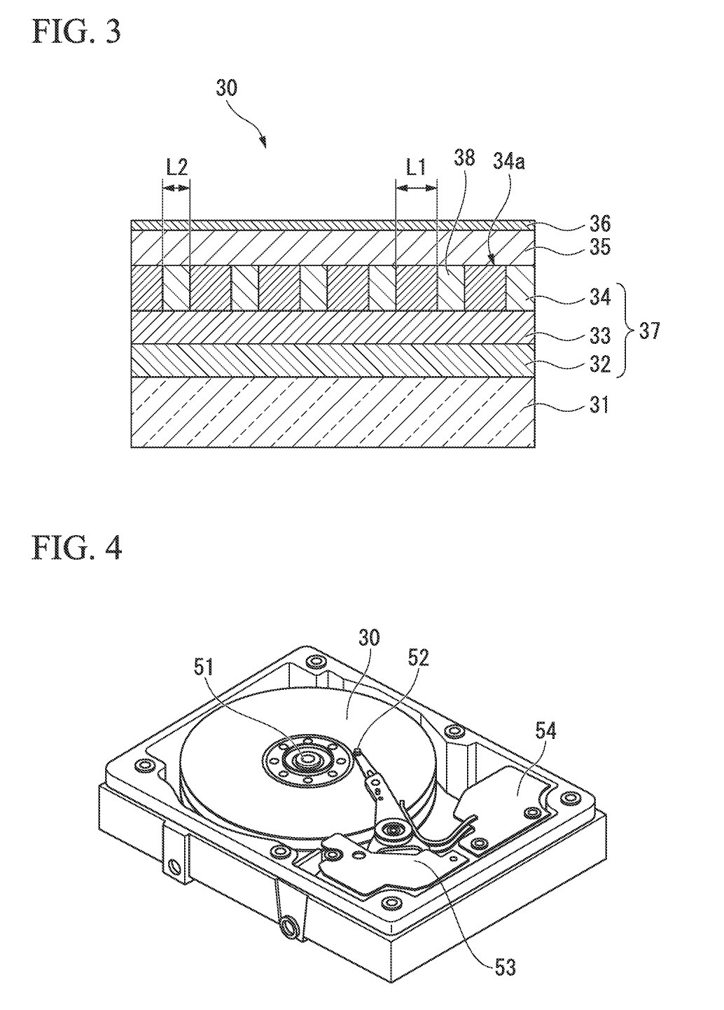

Below, the specific structure of the magnetic recording medium produced by the method according to the present invention can be explained in detail using the discrete track-type magnetic recording medium 30 shown in FIG. 3.

Moreover, the following magnetic recording medium 30 is one embodiment of the present invention. The magnetic recording medium produced by the production method according to the present invention is not limited to the following embodiment, and the constitution of the present invention can be changed as far as the change of the constitution is within the scope of the present invention.

As shown in FIG. 3, the magnetic recording medium 30 has a structure in which a soft magnetic layer 32, an intermediate layer 33, a recording magnetic layer 34 having a magnetic recording pattern 34, a protective layer 35 are sequentially stacked in this order on both surfaces of a non-magnetic substrate 31, and a lubricant film 36 is formed on the top surfaces of the laminate. The soft magnetic layer 32, the intermediate layer 33, and the recording magnetic layer 34 constitute the magnetic layer 37. Moreover, FIG. 3 shows one side of the non-magnetic substrate 31.

Examples of the non-magnetic substrate 31 include aluminum alloy substrates containing Al as main component, such as Al—Mg alloy substrates, glass substrates, such as soda glass substrates, aluminosilicate-based substrates, crystallized glass substrates; silicone substrates, titanium substrates, ceramic substrates, and resin substrates. Among these substrates, Al alloy substrates, glass substrates, and silicon substrates are preferably used. The average surface roughness (Ra) of the non-magnetic substrate 31 is preferably 1 nm or less, more preferably 0.5 nm or less, and most preferably 0.1 nm or less.

The soft magnetic layer 32 is formed to obtain effects, that is, to increase magnetic flux generated by the magnetic head in the perpendicular direction relative to the surface of the non-magnetic substrate 31 or fix firmly the magnetization direction of the recording magnetic layer 34 in which information is recorded to the perpendicular direction relative to the surface of the non-magnetic substrate 1. When a single-pole head for perpendicular recording is used as a magnetic head for recording and reproducing, these effects are remarkable.

The soft magnetic layer 32 can be made of soft magnetic material containing Fe, Ni, or Co. Examples of the soft magnetic material include CoFe-based alloys, such as CoFeTaZr, and CoFeZrNb; FeCo-based alloys, such as FeCo, and FeCoV; FeNi-basd alloys, such as FeNi, FeNiMo, FeNiCr, and FeNiSi; FeAl-based alloy, such as FeAl, FeAlSi, FeAlSiCr, FeAlSiTiRu, and FeAlO; FeCr-based alloys, such as FeCr, FeCrTi, and FeCrCu; FeTa-based alloys, such as FeTa, FeTaC, and FeTaN; FeMg-based alloys, such as FeMgO; FeZr-based alloys, such as FeZrN, FeC-based alloys; FeN-based alloys; FeSi-based alloys; FeP-based alloys; FeNb-based alloys; FeHf-based alloys, and FeB-based alloys.

The intermediate layer 33 can improve the recording and reproducing properties by miniaturizing the crystal particles of the magnetic layer 37. The material for the intermediate layer 33 is not limited, but examples of the material include materials having a hcp structure, an fcc structure, or an amorphous structure. In particular, Ru-based alloys, Ni-based alloys, Co-based alloys, Pt-based alloys, and Cu-based alloys are preferable. In addition, it is also preferable to make a multilayer made of these alloys. For example, multilayers, in which a layer made of Ni-based alloy and a layer made of Ru-based alloy are laminated, a layer made of Co-based alloy and a layer made of Ru-based alloy are laminated, or a layer made of Pt-based alloy and a layer made of Ru-based alloy are laminated, in this order from the substrate side, are preferable.

Specifically, the Ni-based alloy is preferably the alloy selected from the group consisting of NiW alloys, NiTa alloys, NiNb alloys, NiTi alloys, NiZr alloys, NiMn alloys, and NiFe alloys, which contains Ni in a range from 33 at % to 96 at %. In addition, the Ni-based alloy may be non-magnetic material which contains Ni in a range from 33 at % to 96 at % and at least one selected from the group consisting of Sc, Y, Ti, Zr, Hf, Nb, Ta and C. In the present invention, in order to maintain the functions of the intermediate layer 33 and prevent the intermediate layer 33 from having magnetic properties, the content of Ni in the intermediate layer 33 is preferably in a range from 33 at % to 96 at %.

When the intermediate layer 33 is a multilayer, the total thickness of the intermediate layer 33 is preferably in a range from 5 nm to 40 nm, and more preferably in a range from 8 nm to 30 nm. When the thickness of the intermediate layer 33 is in the range, the perpendicular orientation of the recording magnetic layer 34 is remarkably high. Thereby, it is possible to decrease the distance between the magnetic head and the soft magnetic layer during recording. Therefore, it is possible to improve the recording and reproducing properties without decrease of the reproducing signal resolution.

The magnetic layer 37 may be an in-plane magnetic layer in in-plane magnetic recording media or a perpendicular magnetic layer in perpendicular magnetic recording media. In order to achieve higher recording density, the perpendicular magnetic layer is preferable. In addition, it is preferable that the magnetic layer 37 be made of an alloy containing Co as main component. Examples of the preferable magnetic layer 37 include magnetic layers made of CoCrPt, CoCrPtB, or CoCrPtTa, and magnetic layers having a granular structure which is obtained by adding oxides, such as SiO₂, and Cr₂O₃ to the alloys.

When the perpendicular magnetic recording medium is produced, the magnetic recording layer 37, which includes the soft magnetic layer 32 made of soft magnetic material, for example, FeCo alloys, such as FeCoB, FeCoSiB, FeCoZr, FeCoZrB, and FeCoZrBCu, FeTa alloys, such as FeTaN, and FeTaC, or Co alloys, such as CoTaZr, CoZrNB, and CoB; the intermediate layer 33 made of Ru, and the like; and the recording magnetic layer 34 made of 60Co-15Cr-15Pt alloy, or 70Co-5Cr-15Pt-10SiO₂, can be used. In addition, an orientation control film made of Pt, Pd, NiCr, or NiFeCr may be laminated between the soft magnetic layer 32 and the intermediate layer 33.

When the in-plane magnetic recording medium is produced, a laminate, which includes a non-magnetic CrMo underlayer and a ferromagnetic CoCrPtTa magnetic layer, can be used as the magnetic layer 37.

The thickness of the magnetic layer 37 is preferably in a range from 3 nm to 20 nm, more preferably in a range from 5 nm to 15 nm. The thickness of the magnetic layer 37 can be adjusted in the range depending on the kinds of the magnetic alloy used and the laminate structure so as to obtain sufficient head output power. The magnetic layer 37 is required to have a certain level of thickness to obtain a certain level of output power when reproducing. On the other hand, in general, various parameters for showing recording and reproducing properties worsen when the output power increase. Therefore, it is necessary to adjust the thickness of the magnetic layer 37 in view of these matters. Moreover, the magnetic layer 37 is generally formed as a thin film by a sputtering method.

When the magnetic layer 37 has a granular structure, it is preferable that the magnetic layer 37 contain at least Co and Cr as magnetic particles, and at least one selected from the group consisting of Si oxides, Cr oxides, Ti oxides, W oxides, Co oxides, Ta oxides, and Ru oxides at the grain boundary face of the magnetic particles. Examples of the preferable material for the magnetic layer 37 having a granular structure include CoCrPt—Si oxides, CoCrPt—Cr oxides, CoCrPt—W oxides, CoCrPt—Co oxides, CoCrPt—Cr oxides-W oxides, CoCrPt—Cr oxides-Ru oxides, CoRuPt—Cr oxides-Si oxides, and CoCrPtRu—Cr oxides-Si oxides.

It is preferable that the average particle diameter of the magnetic crystal particles having a granular structure be in a range from 1 nm to 12 nm. It is preferable that the total amount of the oxides in the magnetic layer 37 be in a range from 3% by mol to 15% by mol. In contrast, when the magnetic layer 37 does not have a granular structure, the magnetic layer 37 is a layer containing magnetic alloys which contain Co and Cr, and preferably further contains Pt.

Moreover, the magnetic recording medium 30 shown in FIG. 3 is so-called “a discrete track-type magnetic recording medium” in which the magnetic recording pattern 34a formed in the recording magnetic layer 34 is magnetically divided by regions 38 having modified magnetic properties, for example, the regions 38 having coercive force which is about 20% relative to the coercive force of the non-magnetic regions or the recording magnetic layer 34.

In the discrete track-type magnetic recording medium 30, it is preferable that the width L1 of the magnetic recording patterns 34a be 200 nm or less, and the width L2 of the modified regions 38 be 100 nm or less, in order to improve the recording density. In addition, the track pitch P (=L1+L2) is preferably 300 nm or less, and more preferably smaller as possible in order to improve the recording density.

The protective layer 35 may be made of any material which is generally used in the magnetic recording media. Examples of the material for the protective layer 35 include carbonaceous material such as carbon (C), hydrogenated carbon (HₓC), carbon nitride (CN), amorphous carbon, and silicon carbide (SiC), SiO₂, Zr₂O₃, and TiN. The protective layer 35 may be a multilayer containing 2 or more layers. When the thickness of the protective layer 35 exceeds 10 nm, the distance between the magnetic head and the magnetic layer 37 increases, and sufficient input and output properties cannot be obtained. Therefore, the thickness of the protective layer 35 is preferably less than 10 nm.

For example, the lubricant film 36 can be formed by coating a lubricant, which is a fluorine-based lubricant, hydrocarbon-based lubricant or a mixture thereof, on the protective layer 35. The thickness of the lubricant film 36 is generally in a range from about 1 nm to about 4 nm.

The discrete track-type magnetic recording medium 30 can be produced by the production method according to the present invention with high productivity.

### (Magnetic Recording and Reproducing Device)

Below, the magnetic recording and reproducing device (HDD) according to the present invention is explained.

For example, as shown in FIG. 4, the magnetic recording and reproducing device according to the present invention includes the magnetic recording medium 30, a medium-driving member 51 for rotating the magnetic recording medium 30, a magnetic head 52 for recording information in and reproducing information from the magnetic recording medium 30, a head-driving member 53 for moving the magnetic head 52 relative to the magnetic recording medium 30 in the diametrical direction thereof, and a recording and reproducing signal processing system 54 for inputting signal to the magnetic head 52 and reproducing the output signal from the magnetic head 52.

Since the magnetic recording and reproducing device includes the discrete track type-magnetic recording medium 30, high in-plane recording density can be obtained without write track fringing during writing to the magnetic recording medium 30. In other words, the magnetic recording and reproducing device having high recording density can be obtained by using the magnetic recording medium 30. In addition, in order to eliminate the influences of the magnetic transition region in the track edge portions, the width of the reproducing head is made narrower than the width of the recording head in the conventional device. However, since the recording track in the magnetic recording medium 30 is formed so as to be magnetically isolated in the present invention, it is possible to make these widths be substantially the same. Thereby, both sufficient reproduction output power and high SNR can be achieved.

In addition, when the reproducing portion of the magnetic head 52 is a GMR head or a TMR head, it is possible to obtain sufficient signal strength even when the magnetic recording medium has high recording density. Thereby, it is possible to produce the magnetic recording and reproducing device having high recording density. When the floating height of the magnetic head is adjusted to a range from 0.005 μm to 0.020 μm, which is lower than the conventional floating height, it is possible to improve output power and SNR. Thereby, the magnetic recording and reproducing device having large capacity and high reliability can be produced.

Furthermore, when a signal processing circuit using maximum likelihood decoding is combined, the recording density can be further improved. For example, the magnetic recording and reproducing device can obtain sufficient SNR when recording and reproducing under conditions in which the track density is 100 k tracks/inch or more, the linear recording density is 1,000 k bits/inch or more, and the recording density is 100 Gbits/square inch or more.

Moreover, the present invention can be used widely to the magnetic recording medium having a magnetic recording pattern MP which is magnetically divided. Examples of the magnetic recording medium include so-called a patterned medium in which the magnetic recording pattern is regularly positioned per bit, media in which the magnetic recording pattern is positioned along the track, and magnetic recording medium having a servo-signal pattern. It is preferable that the present invention is used to so-called a discrete track-type magnetic recording medium in which the magnetic recording pattern which is magnetically divided is magnetic recording track or servo signal patter, because of ease of production.

Below, the effects of the present invention will be explained with reference to example. Moreover, the present invention is not limited to the following example and the constitution of the present invention can be changed as far as the change of the constitution is within the scope of the present invention.

### Example 1

In Example 1, a vacuum chamber, in which a glass substrate for HD was arranged, was preliminarily evacuated to 1.0×10⁻⁵ Pa or less. The glass substrate used was made of crystallized glass, specifically, Li₂Si₂O₅, Al₂O₃—K₂O, MgO—P₂O₅, or Sb₂O₃—ZnO, and has an outer diameter of 65 mm, an inner diameter of 20 nm, an average surface roughness (Ra) of 2 angstroms (0.2 nm).

Then, a FeCoB film having a thickness of 60 nm as the soft magnetic layer, a Ru film having a thickness of 10 nm as the intermediate layer, a 70Co-5Cr-15Pt-10SiO₂ alloy film having a thickness of 15 nm and a 70Co-5Cr-15Pt alloy film having a thickness of 14 nm as the recording magnetic layer, a polysiloxane film as the dissolution layer, a Mo film having a thickness of 5 nm, and a carbon film having a thickness of 30 nm as the mask layer were laminated on the glass substrate in this order by a DC sputtering method.

Moreover, when the dissolution layer was formed, propylene glycol monomethyl ether acetate solution (pH=7) containing polysiloxane at 1% by mass was prepared, and then the solution was coated to the surface of the recording magnetic layer by spin coating. The spin coating conditions were that the substrate rotation speed was 2,000 rpm, the coating time was 20 seconds, and the thickness of the coated layer was 15 nm. After spin coating, the polysiloxane film was solidified by heating the substrate at 130° C. for 5 minutes.

Then, a resist was coated on the mask layer by a spin coating method to form the resist layer having a thickness of 100 nm. Novolak resin, which is an ultraviolet ray curable resin, was used as the resist. After that, while a glass stamp, which has a positive pattern of the magnetic recording pattern and ultraviolet ray transmittance of 95% or more, was impressed to the resist layer with force of 1 MPa (about 8.8 kgf/cm²), ultraviolet ray having a wavelength of 250 nm was irradiated for 10 seconds from the upside of the glass stamp. Thereby, the resist layer was cured. Then, the stamp was separated from the resist layer. The resist layer had uneven pattern corresponding to the magnetic recording pattern.

Moreover, the uneven pattern transferred to the resist layer corresponded to the magnetic recording pattern of 271 k tracks/inch, the protrusion portion had a circular shape having a width of 64 nm, and the recess portion had a circular shape having a width of 30 nm. The resist layer had a thickness of 65 nm and the depth of the recess portion was about 5 nm. The angle of the side walls of the recess portion relative to the surface of the substrate was about 90°.

Next, the recess portion of the resist layer, the mask layer and the dissolution layer, which are under the recess portion of the resist layer, were removed by dry-etching. The dry-etching conditions were that O₂ gas was 40 sccm, the pressure was 0.3 Pa, the high frequency plasma power was 300 W, the DC bias was 30 W, and the etching time was 20 seconds.

Next, an ion beam was irradiated to the magnetic recording layer at which was not covered with the mask layer to modify the magnetic properties. The ion beam was generated using a mixture gas containing nitrogen gas of 40 sccm, hydrogen gas of 20 sccm, and neon of 20 sccm. The amount of ion was 5×10¹⁶ atom/cm², the accelerating voltage was 20 keV, and the etching time was 90 seconds. Moreover, the magnetic particles in the magnetic layer, at which the ion beam was irradiated, changed to amorphous, and the coercive force decreased to 20%.

Next, the obtained substrate with the laminate was immersed into 30%-isopropyl alcohol (solution temperature: 25° C.) or 200 seconds to dissolve the dissolution layer, and the mask layer and the resist layer on the dissolution layer were removed together with the dissolution layer.

Next, the obtained substrate with the laminate was immersed into a neutral detergent for 10 minutes. After scrubbing cleaning and spin cleaning, the surface of the laminate was etched at about 1 nm by ion beam etching. Then, the DLC film having a thickness of 4 nm was formed by a CVD method, and a lubricant was coated so as to make a film having a thickness of 2 nm. Thereby, the magnetic recording medium was produced.

Then, glide inspection using the produced magnetic recording medium was performed. In this glide inspection, the floating height between the inspection head (head slider) and the surface of the magnetic recording medium was adjusted to 0.2 microinch (6.5 nm). When the signal caused by the collision between a protrusion on the surface of the magnetic recording medium and the inspection head was outputted from the inspection head, the magnetic recording medium was judged as an inferior good.

The signal caused by the collision was not detected in the magnetic recording medium in Example 1.

### INDUSTRIAL APPLICABILITY

According to the present invention, the mask layer which is formed on the magnetic layer is certainly removed within a short time. Due to this, it is possible to produce a magnetic recording medium having high flatness with high productivity. In addition, according to the magnetic recording and reproducing device including the magnetic recording medium, it is possible to further improve magnetic conversion characteristics by using the high flatness.

1. A method for producing a magnetic recording medium having a magnetic recording pattern which is magnetically divided including:
a step in which a magnetic layer is formed on a non-magnetic substrate;
a step in which a dissolution layer is formed on the magnetic layer;
a step in which a mask layer is formed on the dissolution layer;
a step in which the dissolution layer and the mask layer are patterned so as to have a pattern corresponding to the magnetic recording pattern;
a step in which the magnetic layer, at which is not covered with the dissolution layer and the mask layer, is partially modified or removed; and
a step in which the dissolution layer is dissolved by a chemical solution and the dissolution layer is removed together with the mask layer which is on the dissolution layer from the surface of the magnetic layer;
wherein the dissolution layer is formed by coating a chemical solution, in which an organic silicon compound is dissolved in an organic solvent, on the magnetic layer, and solidifying the coated chemical solution, in the step in which the dissolution layer is formed on the magnetic layer.

2. A method for producing a magnetic recording medium according to claim 1, wherein the organic silicon compound contains polysiloxane, and the organic solvent contains propylene glycol monomethyl ether or propylene glycol monomethyl ether acetate.

3. A method for producing a magnetic recording medium according to claim 1, wherein the chemical solution contains isopropyl alcohol.

4. A magnetic recording and reproducing device including:
the magnetic recording medium which is produced by the method according to claim 1;
a media driving portion for driving the magnetic recording medium in a recording direction;
a magnetic head for recording and reproducing to the magnetic recording medium
a head movement means for moving the magnetic head relatively to the magnetic recording medium; and
a recording and reproducing signal processing means for inputting signal to the magnetic head and reproduction output signal from the magnetic head.
